(19) United States
(12) Patent Application Publication
(10) Pub. No.: US 2005/0047434 A1
(43) Pub. Date: Mar. 3, 2005

(54) System and method for network filtering

(75) Inventor: Raymond J. Hopkins, Cinnaminson, NJ (US)

Correspondence Address: STAAS & HALSEY LLP, SUITE 700, 1201 NEW YORK AVENUE, N.W., WASHINGTON, DC, 20005, US

(73) Assignee: Ulticom, Inc., Mt. Laurel, NJ (US)

(21) Appl. No.: 10/650,997

(22) Filed: Aug. 29, 2003

(51) Int. Cl. H04J 3/16

(52) U.S. Cl. 370/466

(57) ABSTRACT

A filter for filtering messages transmitted by a first signaling point and destined for a second signaling point, where the filter has a receiver connected to the first signaling point by a first external communication channel and receiving the messages thereon. The filter may have processing logic, coupled within the filter to the receiver, receiving the messages from the receiver, and filtering the messages by deleting or ignoring redundant messages transmitted to fill-in or maintain a data link between the signaling points. And, the filter may have a transmitter, coupled within the filter to the processing logic, receiving the filtered messages and transmitting them in a format capable of being processed by the second signaling point, whereby the second signaling point receives substantially fewer messages fill-in or maintenance messages.

### BACKGROUND OF THE INVENTION

1. Field of the Invention

The present invention is directed to a system and method for filtering transmission packets. The present invention is also directed to a system and method for filtering maintenance packets transmitted on a serial data link.

2. Description of the Related Art

Modern telephony signaling is used to setup, control, and breakdown telephone calls. Telephony signaling information is shared among signalling nodes using the Signaling System 7 (SS7) protocol, which has its own packet-switched data network generally autonomous from the circuit-switched network that actually carries voice signals or data. Such data networks comprise signaling nodes connected in pairs by serial data links. Any paired nodes will cooperate to maintain their data link by exchanging maintenance packets over the data link. Even when there is no real network-level data activity on the data link, the paired nodes will continue to share maintenance packets to fill, maintain, and monitor their data link.

Put another way, SS7 is a protocol used to manage and control public circuit switching networks, i.e., voice telephony networks. As shown in FIG. 2 (discussed later), the physical, data link, and network layer functions of the SS7 protocol are called the Message Transfer Part (MTP). The data link layer portion of the MTP (layer 2) is based on High Level Data Link Control (HDLC) frame formats. HDLC controllers are inexpensive and readily available for most layer 2 processing. However, SS7 at layer 2 also includes some unique functions that are difficult to implement using an unaltered off-the-shelf HDLC controller. These functions include: counting the number of octets by which a frame is too long; the continuous sending and receiving of fill-in signal units (FISUs) and link status signal units (LSSUs); maintaining a signal unit (SU) error monitor; and filtering duplicate back-to-back frames. Therefore, most SS7 implementations combine an HDLC controller with another controller or processor that handles the non-HDLC SS7 layer 2 functionality.

FISUs are 5 byte frames (three header bytes plus 2 CRC bytes) that are sent continuously back-to-back across a data link in duplicate form when no other data needs to be transmitted on the data link. When a data link becomes idle, it immediately begins transmitting duplicate FISUs. LSSUs are also sent back-to-back during alignment of the protocol. LSSUs are 6 or 7 bytes long. SS7 also differs from other HDLC-based protocols in that the closing flag of one frame can be the opening flag of the next frame. Performance of these SS7 characteristics places considerable load on an SS7 implementation, which will usually implement these characteristics using software.

In a signaling node using an SS7 protocol implementation, a network protocol layer above a data link protocol layer uses the data link layer to perform the maintenance functions such as handling of FISU and LSSU packets. However, this increases the load at the network layer, which may also be used to process network-level traffic for another data link that is not idle. For example, one signaling node may have two data links. If one data link is busy with substantive network-level traffic, and the other data link is idle and carrying only maintenance packets, the signaling node will process the substantive network traffic less efficiently because its network layer must also process the maintenance packets. A system or method is needed to shelter a network protocol engine, such as an SS7 engine or device, or other HDLC-based protocol, from unimportant maintenance packets.

### SUMMARY OF THE INVENTION

It is an aspect of the present invention to provide a system for filtering duplicate maintenance signal units transmitted on a signaling data link.

It is another aspect of the present invention to provide hardware filtering of signaling packets between a pair of data link controllers, where a receiving node receives a bitstream substantially as sent by a sending node, but with bit sequences of unnecessary packets omitted.

It is still another aspect to of the present invention to provide a system for reducing the processing load of a Signaling System 7 (SS7) device by filtering duplicate fill-in signal units (FISUs) and duplicate link status signal units (LSSUs) in a hardware filter situated in front of the input high level data link controller (HDLC controller) of a SS7 device or other HDLC-derived network protocol device.

It is yet another aspect of the present invention to provide a system that filters out or deletes low level or data link level network packets, which are not necessary at the network level, before they are received by a protocol engine handling both the network level and aspects of the data link level upon which the network level is layered.

It is an additional aspect of the present invention to provide a single integrated filter device, used between two signaling points, that receives a signaling bitstream from one signaling point and retransmits to the other signaling point in the protocol format received by the filter, but with original duplicate maintenance signal units omitted from the retransmission.

Another aspect of the present invention is to provide a filter that can provide to a signaling device error information regarding signal units destined for the signaling device but not received due to their filtering by the filter.

It is another aspect of the present invention to provide a system that causes a signaling device built on an HDLC controller to receive a sequence of data link packets where substantially no two sequential packets are duplicate FISU or LSSU packets.

It is still another aspect of the present invention to provide a system for filtering redundant network messages in a way that is transparent to a network and that reduces low level and high level network processing by a device implementing the network's protocol.

The above aspects can be attained by a system that receives signal units transmitted by a first high level data link controller or transmitter, where the signal units are message signal units and fill-in signal units, where some of the fill-in signal units indicate a continuing idle data link condition. The system filters the received fill-in signal units that indicate a continuing idle data link condition by deleting or not forwarding to a second high level data link controller the received fill-in signal units that indicate a continuing idle data link condition. And, the system transmits those of the received signal units that are message signal units and those that are fill-in signal units that do not indicate a continuing idle data link condition, where the transmitted signal units are in a format suitable for receipt by a second high level data link controller or receiver.

The above aspects can also be attained by a filter for filtering messages transmitted by a first signaling point and destined for a second signaling point, where the filter has a receiver connected to the first signaling point by a first external communication channel and receiving the messages thereon. The filter may have processing logic, coupled within the filter to the receiver, that receives the messages from the receiver, and filters the messages by deleting or ignoring redundant messages transmitted to fill-in or align a data link between the signaling points. And, the filter may have a transmitter, coupled within the filter to the processing logic, which receives the filtered messages and transmits them in a format capable of being processed by the second signaling point, whereby the second signaling point receives substantially fewer fill-in or alignment messages.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a simplified SS7 network 50.

FIG. 2 shows a diagram 70 of the SS7 protocol layers compared to the OSI 7-layer network model.

FIG. 3 shows how the three MTP layers of two signaling points cooperate.

FIG. 4 shows the format for an MTP level 2 HDLC packet 100 used to carry SUs.

FIG. 5 shows formats 120 of MTP level 3's MSUs, FISUs, and LSSUs.

FIG. 6 shows a prior art signaling arrangement.

FIG. 7 shows an embodiment of a filter 160 in a signaling or SS7 network 50.

FIG. 8 shows simplified processing and flow of signal messages using filter 160.

FIG. 9 shows an embodiment where a filter 160 is used with essentially unmodified signaling points 52a, 52b.

FIG. 10 shows another embodiment where a filter 160 is used in closer cooperation with a receiving signaling point or signaling device 200.

FIG. 11 shows a conceptual stack-oriented process performed by filter 160.

FIG. 12 shows a detailed embodiment of a filter 160.

FIG. 13 primarily shows operational aspects of the input module 230.

FIG. 14 primarily shows the operational flow of output module 240.

FIG. 15 shows an unfiltered packet sequence 310 and a filtered packet sequence 312.

### DETAILED DESCRIPTION OF THE PREFERRED EMBODIMENTS

SS7 Message Transfer Part and SS7 Messages

As mentioned above, SS7 is a standard protocol used to manage and control public switched telephone networks. An SS7 network does not generally carry voice data, but rather carries SS7 signaling messages that control the telephone circuits of a telephone network. For example, SS7 messages are used to setup and breakdown telephone calls. An SS7 network is usually a separate network from its circuit-switched telephone network, but, to control the circuit-switched telephone network, the SS7 network will have connection points to the switches and devices of the circuit-switched telephone network.

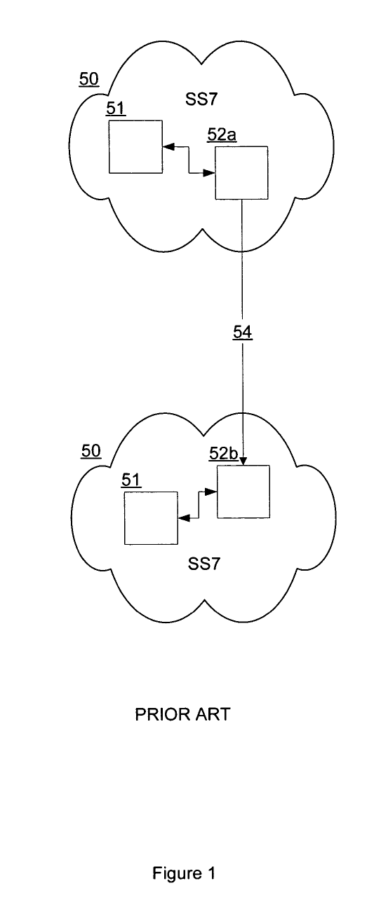

FIG. 1 shows a simplified SS7 network 50. An SS7 network 50 will largely be comprised of nodes or signaling points 51, 52a, 52b, which may be, for example, Signal Switching Points (SSPs) and Signal Transfer Points (STPs), or the like. An SSP is a connection point between the SS7 network and the circuit-switched voice network (not shown) controlled by the SS7 network 50. In accordance with the SS7 standard, pairs of nodes or signaling points 52a, 52b are connected by a data link 54 and will exchange signaling messages or message signal units (MSUs) using the data link 54. Signaling points 51, 52a, 52b may also route SS7 signaling messages across the network 50 from one signaling point to another.

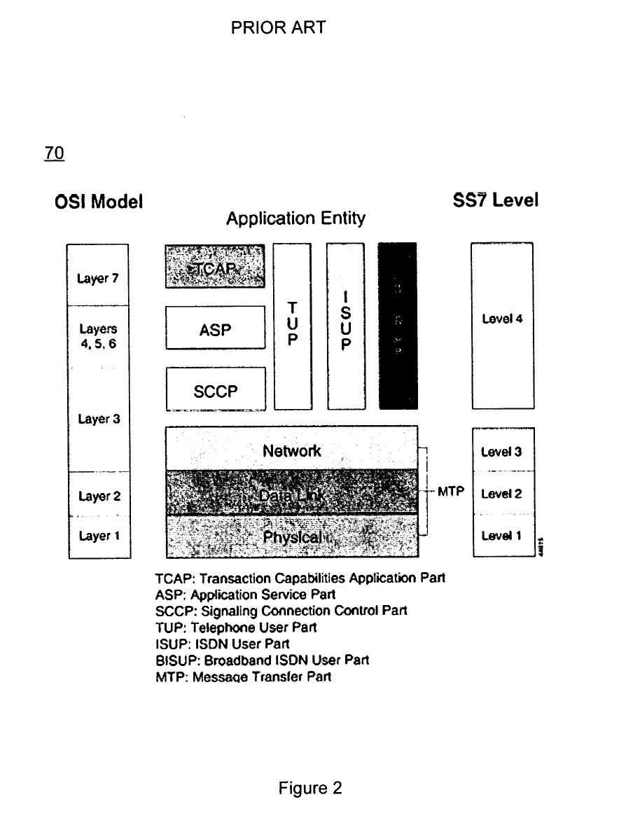

The exchange of signaling messages between signaling points requires each signaling point to implement the SS7 protocol. FIG. 2 shows a diagram 70 of the SS7 protocol layers compared to the OSI 7-layer network model. Each signaling point will implement SS7 levels 1, 2, and 3, and usually all or part of level 4. The various protocols used within the 4 levels or layers of the SS7 protocol accomplish functions called for at each layer.

Of present interest is the Message Transfer Part (MTP), which is formed by SS7's layers 1, 2 and 3. As shown in FIG. 2, the MTP's three layers are: the physical layer (1), the data link layer (2), and the network layer (3). These three layers of the MTP provide the upper user components (e.g. TCAP and ISUP) with node-to-node data transmission across the SS7 network. Transmission functionality typically includes basic error detection and correction schemes and message sequencing. The MTP also provides routing, message discrimination and distribution functions within a signaling node 51, 52a, 52b.

MTP level 1 is the level of physical connectivity. MTP level 1 closely corresponds to layer 1 of the OSI model. A DS0A interface is generally the preferred interface in an SS7 network, although DS1 may become the preferred link interface of the future.

MTP level 2 is the data link level that provides an SS7 network with sequenced delivery of SS7 message packets. The MTP level 2 protocol is a direct point-to-point data link protocol similar to the High Level Data Link Control protocol (HDLC). The HDLC protocol is a common part of several different data link protocols, and is implemented on numerous controller-dedicated chips. The HDLC protocol and the MTP level 2 protocol are similar in that they both involve: data encapsulation in frames; delimitation of frames by flags; zero-bit insertion (“bit stuffing”); CRC generation; frame sequence numbering; and status. MTP level 2 differs from HDLC in that MTP level 2 has three distinct frame types (or signal units): a Fill-in signal Unit (FISU); a Link Status Signal Unit (LSSU); and a Message Signal Unit (MSU). Also, an ending flag in MTP level 2 can also be a starting flag for a next message. Furthermore, HDLC does not provide MTP layer 2's requirement of continuous FISU transmission on a data link that would otherwise be idle (fill-in transmission).

In other words, MTP at level 2 is the data link layer for SS7. Like the OSI data link layer, it is only concerned with the transmission of data or packets directly from one node to the next. It is not concerned with routing or transmission of SS7 data to its final destination in the network. Sequential numbering is used to determine if any packets have been lost during transmission, and each link between two nodes uses its own message numbering series independent of other links.

The MTP at network level 3 depends on the services of data link level 2 and provides routing, message discrimination and message distribution functions. Message discrimination determines who a message is addressed to. A message is passed to and routed at MTP level 3 if it is not a local data link message.

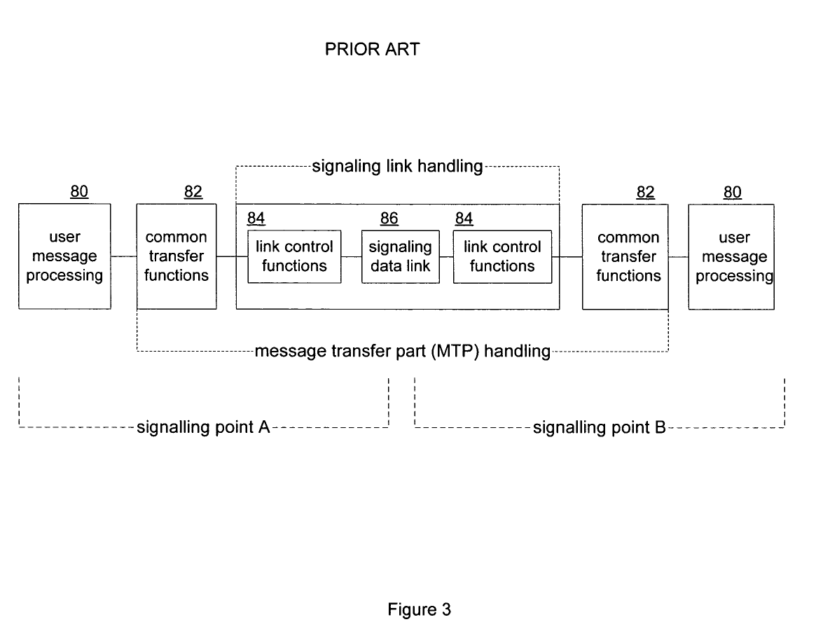

FIG. 3 shows how the three MTP layers of two signaling points cooperate. Above the MTP levels, the needs of SS7 user applications or user message processing parts 80 are implemented by common transfer functions 82 of level 3 of the MTP. The common transfer functions 82 of level 3 are implemented by link control functions 84 of level 2. The link control functions 84 of level 2 are implemented by the signaling data link 86. In sum, the physical, data link, and network layer functions are layered together to make up the Message Transfer Part (MTP) of SS7. Notably, at any given signaling point, the MTP level 3 (network layer) uses the MTP level 2 (data link layer) to send FISUs and LSSUs to an adjacent signaling point.

Signaling Units Handled by MTP Level 2 (HDLC+) and MTP Level 3

SS7 signaling information, whether of local or network scope, is passed over a data link in messages, which are called signal units (SUs). Paired data-linked signaling points continuously exchange SUs in both directions on their data link, if the data link is in service. As mentioned previously, SS7 uses three different types of signal units: FISUs, LSSUs, and MSUs, which MTP level 3 sends through level 2 HDLC type packets or frames.

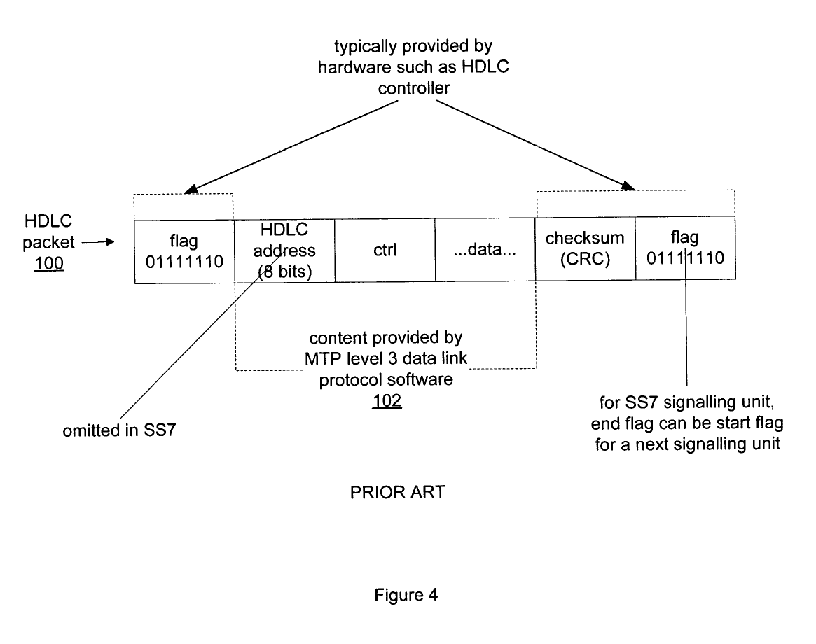

FIG. 4 shows the format for an MTP level 2 HDLC packet 100 used to carry SUs. The payload, envelope, or content 102 is carried by the frame or packet 100. The flags and CRC (checksum) are provided by the data link level (MTP level 2), generally by an HDLC controller or chip. The payload 102 is filled and used by MTP level 3.

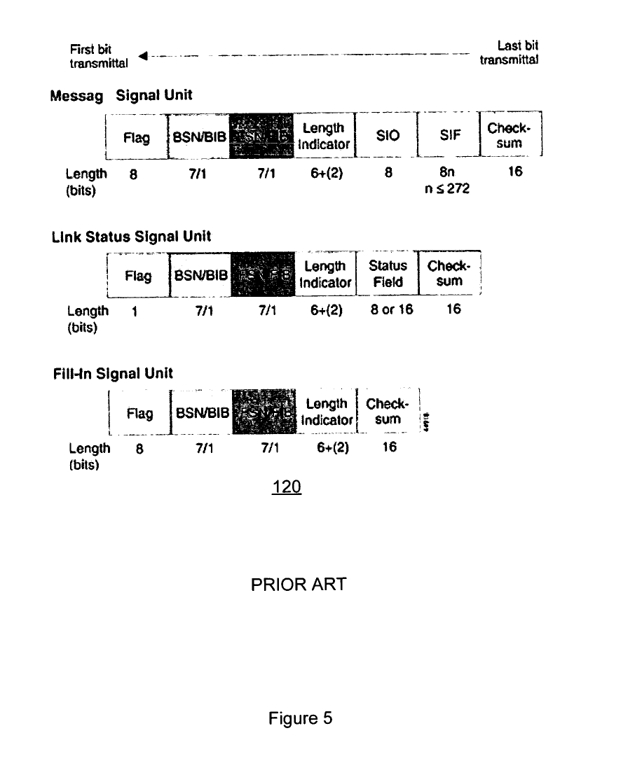

FIG. 5 shows formats 120 of MTP level 3's MSUs and level 2's FISUs and LSSUs. Other than the checksum and flags, the fields are provided and used by MTP level 3. The flag pattern is always “01111110” and is guaranteed to be a unique bit pattern in the bitstream carrying the SUs. The flag is a delimiter in a signal unit and it marks the end of one SU and the beginning of another. The BSN/BIB and FSN/FIB are octets that hold the backward sequence number (BSN), the backward indicator bit (BIB), the forward sequence number (FSN), and the forward indicator bit (FIB). MTP level 3 uses these sequence fields for confirming receipt of and controlling the order and flow of SU packets. The 16-bit checksum is calculated by the transmitting signaling point based on the transmitted message. The receiving signaling point recalculates the checksum, and if it is corrupted, a retransmission is requested. The re-transmission will have new sequence numbers. The length indicator (LI) is the number of octets between the LI field and the checksum. The Li can be used to check the integrity of an SU and to differentiate between different types of SUs (FISU=0, LSSU=1 or 2, MSU>2). The SIO is the service indicator octet (type of service), and the SIF indicates service information fields (data).

The data link layer portion of MTP layer 2 is based on HDLC frame formats. However, SS7 at layer 2 also includes some unique functions that are difficult to implement using an unaltered HDLC controller. These functions might include; checking whether a frame is too long for its type, sending/receiving of fill-in signal units (FISUs) and link status signal units (LSSUs), SU error monitoring, etc. Thus, typical SS7 protocol implementations use an HDLC controller in conjunction with software run by a general-purpose processor or controller, which provides the necessary SS7 functionality. However, this approach is inefficient because FISU and LSSU handling, which is by nature local data link layer activity, must be handled by the MTP level 3 (network level) implementation, which will also handle non-local network traffic. For SS7 protocol implementations that use a generic HDLC controller, the network-level performance is degraded because the network layer must also process data link-level activity.

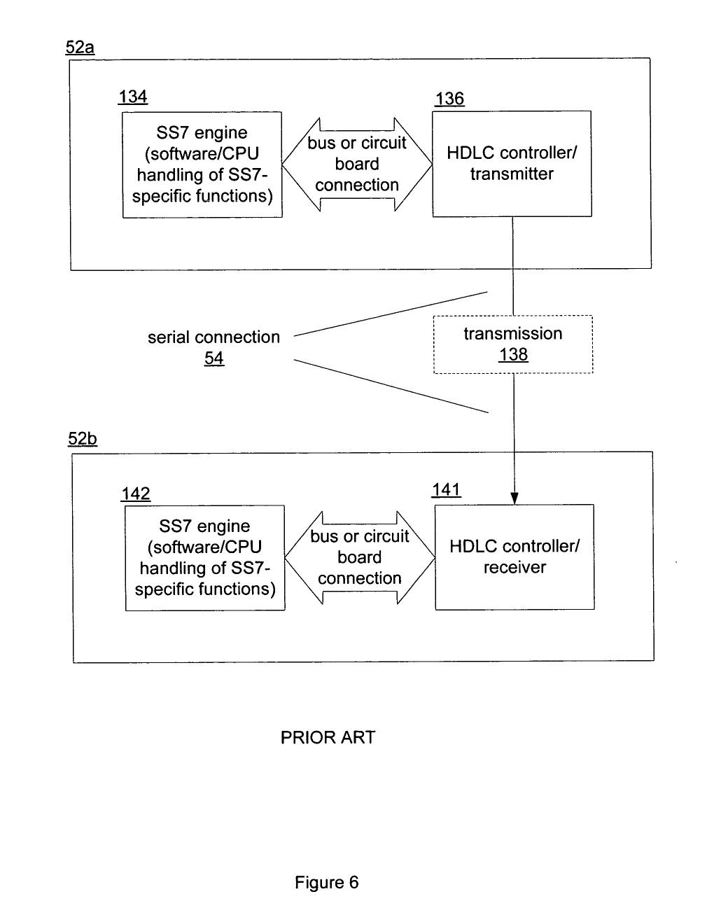

FIG. 6 shows a prior art signaling arrangement. Upstream signaling point 52a may continuously generate in software 134 FISU/LSSU messages. The SS7 engine 134 determines at the MTP network level that the data link is idle or needs to be aligned, and accordingly generates an FISU or LSSU that is framed and sent by an HDLC controller/transmitter 136 as a serial transmission 138.

Downstream signaling point 52b receives the serial transmission 138 of the FISU/LSSU with its HDLC controller/receiver 141. The controller/receiver 141, preferably using the HDLC controller/receiver 141, sees that the FISU/LSSU is a higher-level (network level) message, interrupts the processing of the software/processor 142, and passes the FISU/LSSU to the software/processor 142 for network-level handling. The software/processor 142 then handles the FISU/LSSU, for example by error maintenance checking, sequence checking, sending an acknowledgment/negative-acknowledgment to the signaling point 52a (using another serial connection, not shown), bringing the link into alignment, etc. If the FISU/LSSU is a duplicate of the previously received message, then no real action is taken (but some maintenance may result, such as adjusting an error monitoring state).

Protocols other than SS7 are built on HDLC. For example, ATM will have a similar arrangement to that shown in FIG. 6. Other protocols will have similar problems from redundant maintenance traffic and will similarly benefit from the filtering discussed later.

The error monitoring of the downstream signaling point 52b typically uses a “leaky bucket” algorithm. Messages in a sliding window are checked for errors as they are received. Each message in error increases the error count. Each message not in error decreases the error count. An error condition may be deemed to exist when the error count reaches a given threshold.

Redundant or Non-Essential Maintenance Message Units

As mentioned above, FISUs are 3 byte SUs (or 5 byte frames if including the 2 CRC bytes) that are sent continuously back-to-back when no other data needs to be transmitted on a data link. LSSUs are also sent back-to-back during alignment of the protocol on the data link. LSSUs are 4 or 5 bytes long (6 or 7 byte frames if including the CRC).

In many implementations of SS7, the SS7 protocol functions are layered on top of an HDLC device. HDLC is a packet protocol on a bit-synchronous network. HDLC provides a serial stream of bits. SS7 uses an HDLC device to send packets. The data or payload portion of the HDLC packet may be a FISU, an LSSU, or an MSU. LSSUs are used for synchronization training when bringing up a link. Bringing up a link starts by sending an LSSU message and waiting for the equivalent message to come back. Another LSSU message is sent in response, and so forth, until the link is established. Neither LSSUs nor FISUs travel beyond a linked pair of nodes.

Once a link is established and both nodes are aware that they are talking with one another, LSSUs and FISUs are used at the lower levels of the SS7 protocol (level 3 and level 2). The LSSUs and FISUs are received at and mostly ignored at those levels by an SS7 protocol engine or implementation because they don't carry any information that has to go beyond the local link.

The LSSU training packets are short packets with a special sequence. Once they are exchanged a link enters service. After entering service, an upstream node, when not sending real network traffic, keeps the data link busy by sending FISUs. The FISUs indicate to the downstream receiving node that the upstream sending node and the data link are operational and the upstream node has no data to send. Depending on the exact protocol or SS7 version, FISUs may need to be sent either periodically or continuously. Some protocols specify an interval, and others do not.

Duplicate back-to-back FISUs or duplicate back-to-back LSSUs have the same forward sequence number (FSN) and forward indicator bit (FIB), and the same backward sequence number (BSN) and backward indicator bit (BIB). The FSN is the number of the message going to the destination end. The BSN is the number from the other direction that is being acknowledged or negatively-acknowledged. The FIB/BIB gets inverted when a packet is negatively-acknowledged, in which case it must be resent.

A FISU is simply a filler packet, which can also be used for acknowledging data coming from the other direction. If there is nothing to send on one end of a link, and the other end of the link has an MSU to send, the MSU can be acknowledged with a FISU. The FSN remains unchanged, but the BSN changes to identify the message being acknowledged. In other words, a BSN is the only useful information contained in a received FISU.

On an SS7 data link, errors are usually counted in a sliding window to monitor the ongoing condition of the data link (whether or not the data link is up or not). As mentioned above, a leaky-bucket algorithm is usually used to determine a fault on the link. Received acknowledgments contribute to the error count. The number of packets received in error also contributes to the error count. However, in a sequence of FISUs, only the first FISU contains useful information. If conditions have not changed after the first FISU is sent, then the first FISU is resent repeatedly. The fact that FISUs are being received (i.e. not getting ERRs) usually affects the monitoring or error determination because the error count will decrease. That is to say, part of the monitoring or error determination involves taking into account the fact that error-free packets are being received on the data link. Normally, a lack of packets will not be determined directly. For example, if a line sends flags when it becomes idle, errors would not normally be generated. Such an error condition would eventually be found by a timer-expiration on a link poll message. Also, error detection for the Japanese version of SS7 (J7) is performed almost exclusively via a set of timers rather than the leaky bucket used by most other versions.

As discussed above, SS7 is a superset of HDLC. Most chipmakers make HDLC chips. Most implementations of SS7 use an HDLC chip to perform a task they are not fully equipped to perform; SS7. SS7-specific portions of the SS7 protocol that cannot be performed by an HDLC chip are usually performed in software. The non-HDLC functionality of SS7 includes the link establishment functionality (LSSU handling) and the idle or error detection functionality (FISU handling).

Since FISUs are short, many individual FISUs tend to be sent and received. An accelerator board is usually used in conjunction with an HDLC chip to implement the lower levels (2 and 3) of the non-HDLC portions of the SS7 protocol. In one aspect, the present invention handles the front end of the SS7 protocol to help reduce the accelerator board's overhead of processing the numerous FISUs that do not contain useful information. That is to say, a significant portion of the processing time of a signaling device is spent on handling these frequent and short packets. Each received packet generates an interrupt, for example in software 134, which is not processed as quickly as a normal sequential instruction. Considering that each FISU/LSSU packet is only 3-5 bytes of data (6-8 bytes total if including lead flag and CRC), and considering that interrupts in general are costly to handle, FISUs and LSSUs significantly degrade the performance of an SS7 protocol implementation or engine; there are many interrupts to handle a relatively small amount of useful information. By comparison, the average data packet for a TCAP application is 30 bytes, and slightly less for an ISUP application. In contrast, FISUs are about 3 bytes. One fully loaded MSU is equal to about 5 FISUs, so FISUs consume a disproportionate share of processing time. Even when interrupts are not used, there is considerable overhead cost, for example the providing, managing, and freeing of buffers used to process the FISUs.

It may be noted that an idle link will exchange redundant FISUs, but periodic poll messages at the network layer (a layer above the link layer) have unique sequence numbers and are not transmitted as duplicates.

FISU/LSSU Filtering

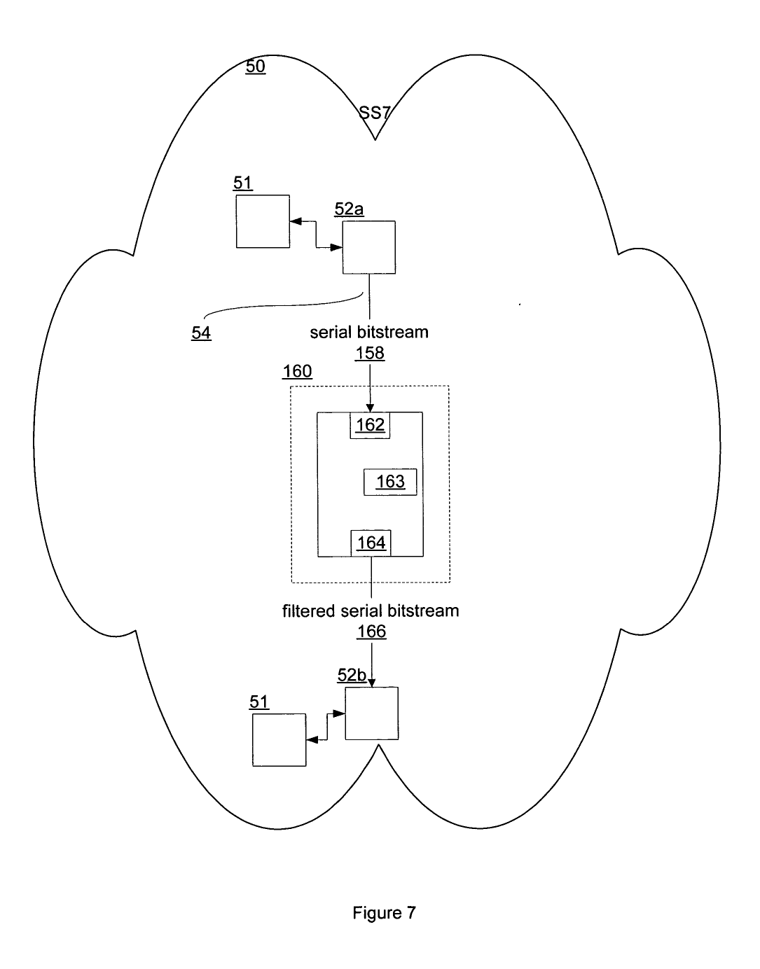

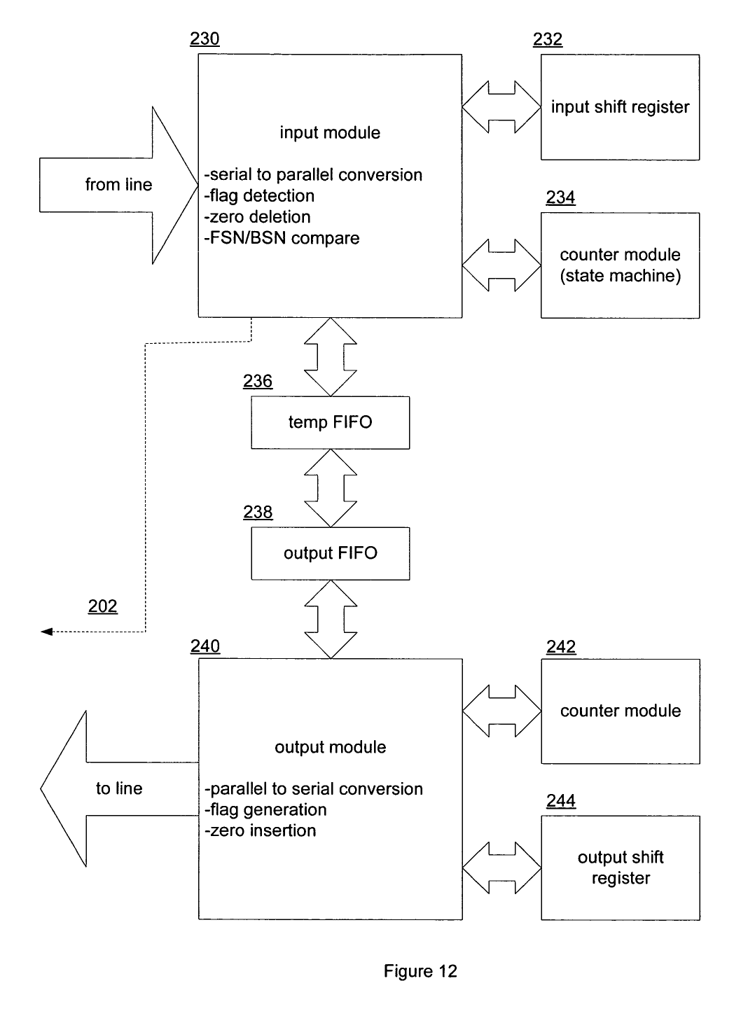

FIG. 7 shows an embodiment of a filter 160 in a signaling or SS7 network 50. Although shown in one signaling network 50, the filter can be used between signaling points 52a, 52b that cross a network boundary, for example international SCCP gateways. Upstream signaling point 52a is connected to the filter 160 by a physical level connection such as serial line 54. The filter 160 is preferably a single autonomous processing unit or device with circuitry coupling a receiver 162, a logic chip or circuitry 163, and a transmitter 164. Downstream signaling point 52b is connected to transmitter 164 to receive a filtered bitstream 166 from the filter 160. A detailed description of an embodiment of the filter 160 is given later with reference to FIG. 12.

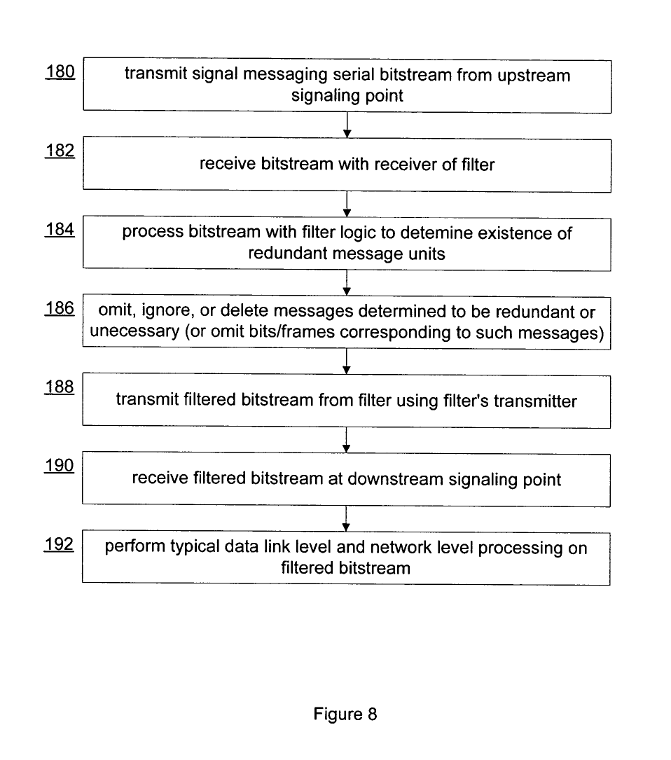

FIG. 8 shows simplified processing and flow of signal messages using filter 160. Upstream signaling point 52a transmits 180 a transmission 138 or serial bitstream 158 of data link frames carrying a mix of duplicate and non-duplicate message units; FISUs, LSSUs, and SMUs. The bitstream 158 is intercepted or received 182 by a filter 160 with a serial controller or receiver 162. The logic 163 of the filter 160 processes or analyzes 184 the serial bitstream 158 to determine whether there are any redundant and therefore unnecessary maintenance signal units, which typically are back-to-back duplicate FISUs or back-to-back duplicate LSSUs. As discussed in detail later, duplicity is preferably determined based on the content of the message units.

Any such redundant maintenance messages are filtered, deleted, ignored, or otherwise omitted 186 from the bitstream by the filter's 160 logic 163. The filter 160 then transmits 188 from its serial transmitter 164 a filtered bitstream 166 that is substantially identical to the bitstream 158, but with the duplicate maintenance message units (or bitstream bits corresponding thereto) omitted. “Substantial” indicates that minor other differences not necessarily related to filtering may occur, depending on implementation choices, noise, etc. For example, a bit may be intentionally flipped if the filter 160 performs some form of error correction decoding (error correction is not required or preferred). The receiving signaling point 52b receives 190 and processes 192 the filtered bitstream 166 without having to respond to or handle the now-omitted 186 duplicate FISUs/LSSUs. The MTP level 3 (network level) communication between the signaling points 52a, 52b is not substantively affected, and the load on the receiving signaling point 52b is transparently reduced. Although preferably all of the unnecessary maintenance message units are filtered, in some circumstances it may be desirable to filter most or substantially all of the duplicate maintenance message units. For example, a small amount of duplicates may be leaked through to maintain line status or to satisfy a peculiarity of a particular receiving signaling point. “Substantially all” indicates that even though some duplicates may be passed through by the filter, the load on the receiving signaling point is nonetheless significantly reduced.

In other words, the filter 160 receives MTP level 1 (physical) bits, discerns MTP level 2 frames carrying non-essential signaling information such as MTP level 3 message units (duplicate FISUs/LSSUs), which are filtered out or eliminated by the filter 160. Preferably, the same unfiltered MTP level 1 bits in their original sequence (carrying the same unfiltered message units) are sent to the downstream signaling point 52b by the filter 160 in the format with which they were received 182. The filtered bits are transmitted 188 in the same format that they would have been if they had not passed through the filter 160. The signaling point 52b performs its usual protocol processing, but does not need to perform any related MTP level 1, 2, or 3 processing of the duplicates. Preferably, data received by signaling point 52b is not encapsulated by another protocol, such as a non-SS7 frame relay protocol. Furthermore, the effect on error-detection resulting from the reduction or lack of FISUs (due to filtering) can be compensated for by either receiving a count (e.g. filtered packets) from the filter logic, or by checking the time since the last packet was received, which is possible because the fixed length of a FISU makes it possible to calculate how many FISUs would have been received but for the filtering.

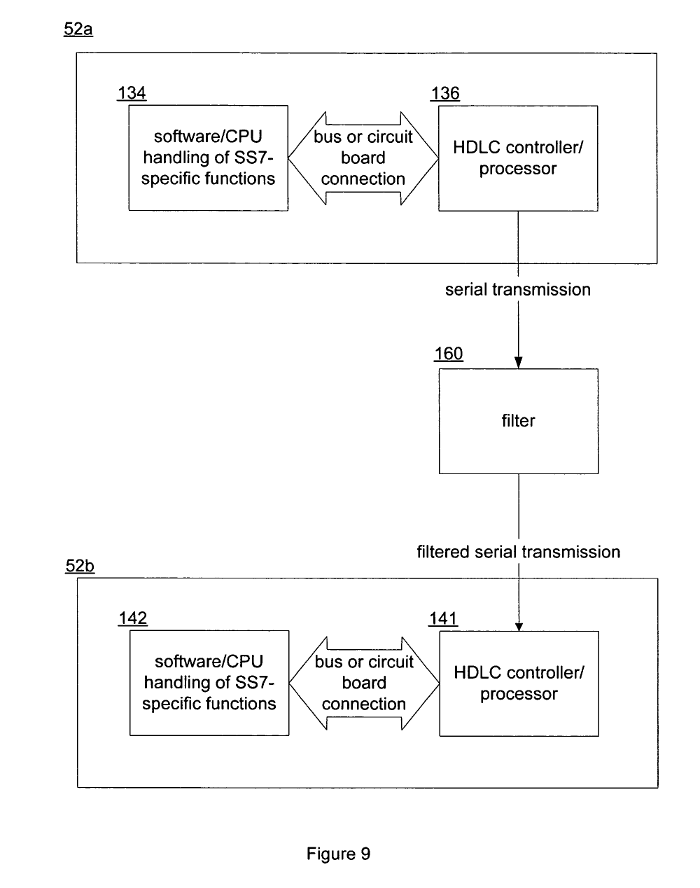

FIG. 9 shows an embodiment where a filter 160 is used with essentially unmodified signaling points 52a, 52b. In this embodiment, the filter 160 may be placed in-line between the transmitting upstream signaling point 52a and the downstream signaling point 52b. The downstream signaling point 52b can be any known signaling point using any SS7 implementation that is compatible with the signaling point's 52a, 52b signaling network 50.

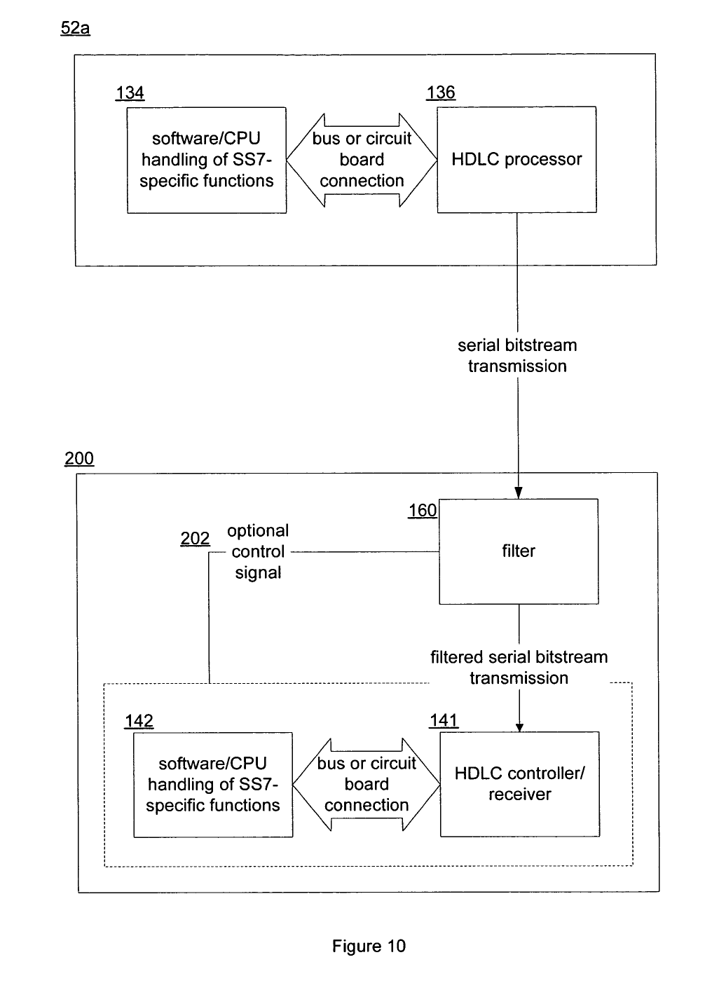

FIG. 10 shows another embodiment where a filter 160 is used in closer cooperation with a receiving signaling point or signaling device 200. Like the embodiment in FIG. 9, the filter in FIG. 10 is arranged between the HDLC/SS7 output of the upstream node and the HDLC/SS7 input of the downstream node. However, in the embodiment shown in FIG. 10, an optional control signal path 202 is provided between the filter 160 and the signal device 200. The control signal path 202 may be used to exchange information between the filter 160 and signaling device 200. For example, if the filter 160 keeps a count of received errors or frames in error or of frames not in error, then the signaling device 200 can perform its error monitoring based on errors or frames possibly filtered by the filter 160. The link error monitoring function (e.g. leaky bucket) of the signaling device 200 will be able to take into account all of the signal units transmitted by the upstream signaling point 52a, including those that are filtered by the filter 160. Furthermore, the same type of error count information could be multiplexed onto the serial input of the receiving box, thus allowing the same filter to be used with either a modified or an unmodified SS7 receiver. More generally, there can be feedback from the filter without a separate line. To be detected by the HDLC logic, such information can be formatted into an HDLC packet so the HDLC receiver would see it. For example, if the LI field was set to 0, but data was included, the layer 2 logic could detect that illogical packet and use the packet's data. It is preferable to send the count information via a parallel path if possible. Also, if a T1 or E1 line is being used, the count type data could be passed in an unused time slot, or via out of band signaling. It is also possible that information relating to messages discarded by the filter 160 could be passed to the destination device in an unused portion of an unfiltered signal unit, or it could be passed in an LSSU generated or inserted into the bitstream by the filter 160. A unique type of frame could be used. Other methods of providing filtration information are understood. Furthermore, different filter arrangements are possible. The filtering can be done before or after the serial line interface. If it is done before the serial line interface, then a line interface must be provided before and after the logic to convert the “line” to logic levels and then back again to be passed to the receiver. If the filter is in the same “box” as the receiver then it is easier to put it in the line between the line receiver and the HDLC chip.

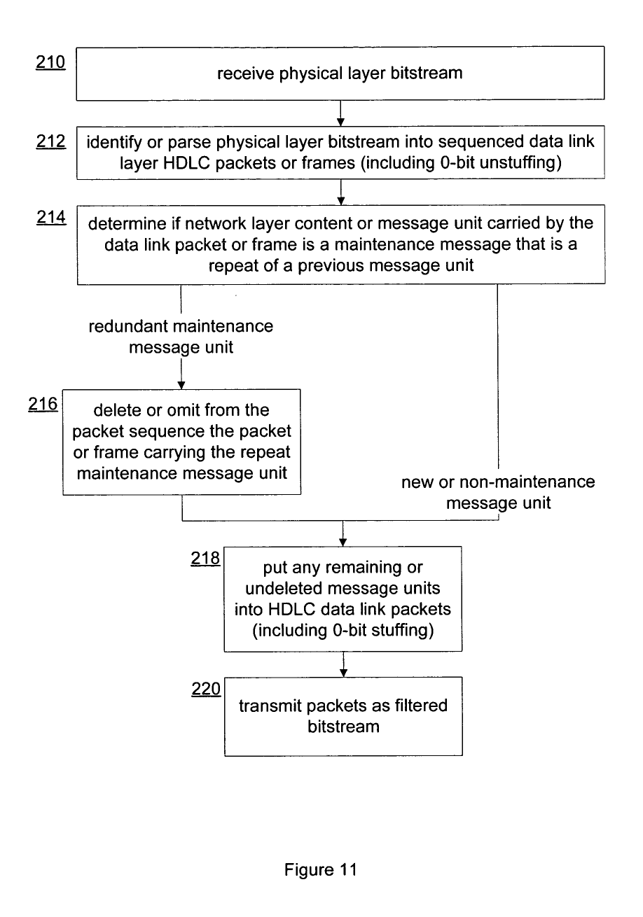

FIG. 11 shows a conceptual stack-oriented process performed by filter 160. An actual implementation may differ. The filter 160 receives 210 a physical layer bitstream. The filter 160 identifies or parses 212 the physical layer bitstream into sequenced data link layer HDLC packets or frames (including 0-bit unstuffing), preferably in the order that they are received in the bitstream (reordering in accordance with sequence numbers may be called for in some circumstances). The filter determines 214 if network-layer content (e.g. a message unit) carried by the data link packet or frame is unnecessary, for example if it is a maintenance message that is a repeat of a preceding message unit. If the current data link frame is determined 214 to be unnecessary, e.g. a redundant maintenance message, then the filter 160 deletes or omits 216 from the packet sequence the unnecessary packet or frame carrying the repeat maintenance message unit. Any remaining or undeleted message units are put 218 into HDLC data link packets (including 0-bit stuffing). The packets are then transmitted 220 as a bitstream.

The process of FIG. 11 includes steps that may not be essential for filtering but are helpful in understanding the conceptual effect of the filter 160. For example, the putting 218 (packetizing/framing) may not actually be necessary, because a frame being passed can simply be sent as received. The filter looks into MTP level 3 information to prevent certain information from moving up the protocol stack of the downstream signaling device 200.

FIG. 12 shows a detailed embodiment of a filter 160. The embodiment in FIG. 12 may be readily implemented, for example, using a field programmable gate array (FPGA). An input module 230 receives incoming data, and has functionality for serial-to-parallel conversion, flag detection, zero deletion, and sequence number comparison. An input shift register 232 and counter module or state machine 234 are provided for maintaining input state information. A temporary FIFO 236 and output 238 carry data to an output module 240. The output module 240 uses a counter module 242 and output shift register 244 for maintaining output state information. The output module performs inverses of some of the operations in the input module 230, including: parallel to serial conversion, flag generation, zero insertion, and sending output.

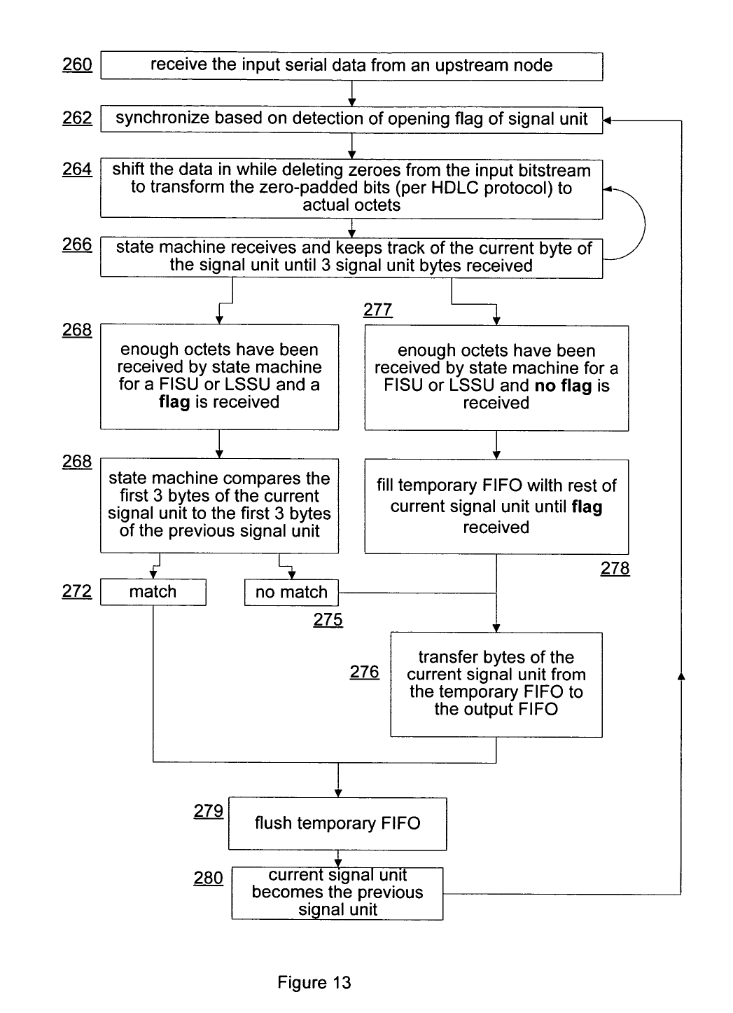

FIG. 13 primarily shows operational aspects of the input module 230. The input module 230 receives 260 the input serial data from an upstream node and synchronizes 262 by detecting an opening flag of a signal unit. The input module 230 uses the input shift register 232 to shift 264 the data in while deleting zeroes from the input bitstream to transform the zero-padded input bits (per HDLC protocol) to actual octets. The use of octets or bytes simplifies the logic circuitry. As the signal unit octets are received and placed in the temporary FIFO 236 and fed to the state machine 234, the state machine 234 keeps track 266 of the current byte of the signal unit (i.e. the current location in the packet). When the state machine 234 receives sufficient octets of a signal unit to recognize a FISU or LSSU and a flag is received 268 (indicating the end of the current signal unit and the start of another), the state machine 234 compares 268 the first 3 bytes of the current signal unit to the first 3 bytes of the previously received signal unit. If they match 272, the current signal unit is discarded by flushing 279 the temporary FIFO 236. If the current signal unit does not match 275 the previously received signal unit then it is known that the FISU/LSSU is not a duplicate, in which case the bytes of the signal unit are transferred 276 from the temporary FIFO 236 to the output FIFO 238.

If, after the first three bytes have been received 266 and no flag is received next 277, then the current signal cannot be a FISU or LSSU, so the temporary FIFO 236 is filled 278 with the rest of the signal unit, and the bytes of the signal unit are transferred 276 from the temporary FIFO 236 to the output FIFO 238. Finally, once the current signal unit has been processed (either discarded or passed through), the temporary FIFO 236 is flushed 279, and the current signal unit becomes 280 the previous signal unit for comparison to the next signal unit, which begins being processed according to synchronization 262 based on the flag detected in 268 or 278.

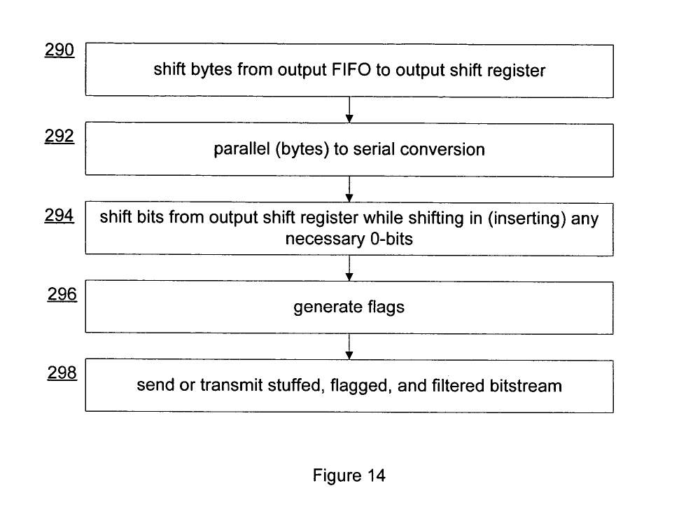

FIG. 14 primarily shows the operational flow of output module 240. The output module 240 performs the inverse function of the input module 230. The output module 240 shifts 290 bytes out of the output FIFO 238. The output module 240 processes according to the rules for shifting out data; it shifts 292 each bit out one at a time, while bit stuffing—shifting in an extra zero whenever there are 5 consecutive 1s not in a start/end flag or in an idle flag (01111111). Flags, if not passed through, are generated 296. Finally the filtered HDLC-compliant bitstream is passed 298 to the receiving HDLC controller.

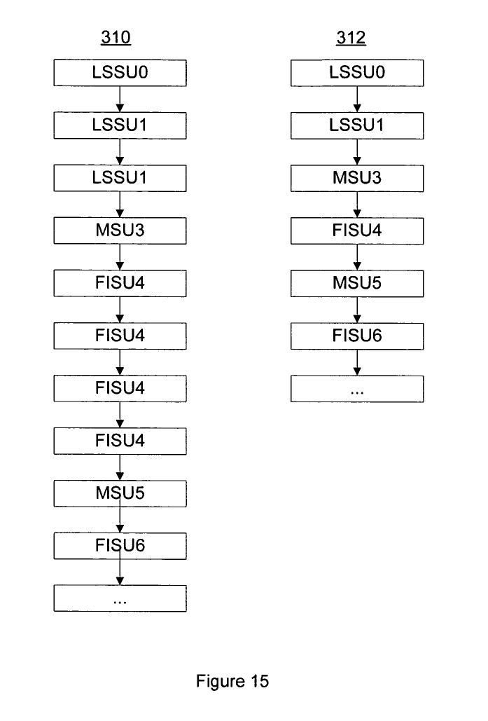

FIG. 15 shows an unfiltered packet sequence 310 and a corresponding filtered packet sequence 312. The unfiltered packet sequence 310 is a typical signaling transmission. The filtered sequence 312 is an example of what would be emitted by a filter of the type discussed above. A transmission medium such as a serial line or circuit connection receiving the output of such a filter will carry a bitstream corresponding to the filtered packet sequence 312. The filtered sequence 312 will be a sequence of ordered signal units formatted according to a network level signaling protocol and encapsulated in data link packets formatted according to a data link protocol understandable by the filter. Preferably, the filter 160 sends the passed-through signal units as individual discrete transmissions. For substantially all of the filtered packets 312, no two sequential packets carry fill-in signal units that have identical forward and backward sequence numbers. When the data link uses repeated packets for idle line maintenance, at least two adjacent signal units in sequence 312 will be non-duplicate signal units that correspond to an idle period on the line.

A typical transmission media used for a data link may require keeping traffic on the line for synchronization purposes of the media hardware or interfaces. For instance, a certain density of 0-bits to 1-bits must be maintained, or the transmission media may not be able to maintain synchronization. In such a case it is possible to continue to use FISUs for error detection by counting FISUs and passing the count through to the downstream signaling node. Or, the filter can keep a count in a counter read periodically by the receiving node.

There are some protocols built on HDLC that do speculative retransmission. For example, a satellite link has a long transit time. After sending a packet on a satellite link, there can be a delay waiting for an acknowledgment or negative-acknowledgment. In this case, there is idle time on the link. Packets that have not been acknowledged or negative-acknowledged may, in anticipation of possible error, be resent automatically. Back to back duplicate MSUs may be received at the receiving end. These duplicate MSUs can be discarded. The filter described above is able to handle these automatic resends. Resent MSU packets that were originally not in error can be correctly discarded, and resent packets corresponding to original packets that were in error when first transmitted will not be discarded because they won't be duplicates. This condition can also be determined based on the CRC. That is to say, errors are preferably passed through and handled at a higher level (e.g. MTP level 3) by the destination signaling or network device. Therefore, although the filter can be designed to handle errors using the CRC, it is generally not necessary.

A filter of the type discussed above can be implemented by a field programmable gate array (FPGA), an application specific integrated chip (ASIC), or other discrete logic circuit or device. A simple general-purpose processor may also suffice.

Although the filter is particularly applicable to SS7 data links, it is also applicable to other network protocols. For example, ATM also uses maintenance packets. Generally, the filter is applicable to filler packets that can be recognized or filtered by a known grammar. In the SS7 case, since FISUs are short, they are easy to recognize. However, ATM has similar small filler packets, each having a 4-byte header that identifies the filler packet. In the ATM case, the filter would deal with ATM functionality instead of HDLC functionality. In general, the filter can be adapted to sit in front of any HDLC chip that supplements a higher level network protocol built on HDLC.

The present invention has been described with respect to an apparatus for filtering data transmitted according to a telephony signaling protocol, the telephony signaling protocol comprising a physical layer protocol, a data link layer protocol, and a network layer protocol. The apparatus may have a receiver capable of receiving frames sequenced and formatted according to the data link layer protocol, where the frames carry signaling units formatted according to the network layer protocol. The apparatus may have a processing circuit capable of identifying frames in the bitstream that carry a network layer maintenance signaling unit that is duplicative of a maintenance signaling unit in a preceding frame. And, the apparatus may have a transmitter capable of transmitting the received frames less some or all of the identified frames. The filter logic can also be provided with a monitor mode to monitor a line for specific messages that would then be forwarded to the receiver for processing. This type of negative filtering blocks everything other than what is to be passed through. For example, this type of filtering is typically used for billing applications where only call set up and tear done information is sought.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A method of filtering in a signaling network, the method comprising:
receiving signal units transmitted by a first high level data link controller, where the signal units comprise message signal units and fill-in signal units, where some of the fill-in signal units indicate a continuing idle data link condition;
filtering at least some of the received fill-in signal units that indicate a continuing idle data link condition by not forwarding to a second high level data link controller at least some of the received fill-in signal units that indicate a continuing idle data link condition; and
forwarding those of the received signal units that are message signal units and those that are fill-in signal units that do not indicate a continuing idle data link condition.

2. A method according to claim 1, wherein the forwarded signal units are forwarded in a format capable of being directly received and understood by a second high level data link controller, and wherein the first and second high level data link controllers are capable of directly exchanging signal units over a shared data link.

3. A method according to claim 1, wherein indicia of the not-forwarded fill-in signal units is made available to a signaling device that receives the forwarded signal units using the second high level data link controller.

4. A method of filtering data link frames communicated over a data link between a data link transmitter and a data link receiver, where the frames are transmitted according to a data link protocol, the method comprising:
receiving the data link frames generated by the transmitter according to the data link protocol; and
based on the received data link frames, forwarding at least some of the received data link frames to the data link receiver while preventing the data link receiver from receiving at least some redundant frames that are for at least one of maintaining and continuously filling the data link.

5. A method according to claim 4, wherein indicia of the not-forwarded data link frames is made available to a network device that receives the forwarded signal units using the receiver.

6. A method according to claim 4, wherein the data link frames encapsulate network data generated and formatted by a network engine in accordance with a network protocol layered on top of the data link protocol.

7. A method according to claim 6, wherein the data link transmitter comprises an HDLC transmitter, and wherein the data link receiver comprises an HDLC receiver.

8. A method of filtering with a single filter device situated in series between a transmitting node and a receiving node communicating over a data link therebetween, where the transmitting node transmits a first bitstream of packets, and where the receiving node receives a second bitstream of packets, the method comprising:
receiving with the filter the first bitstream; and
sending, with the filter, the second bitstream, where the second bitstream matches the first bitstream but with redundant or duplicate maintenance signaling units omitted.

9. A method of filtering within a single integrated filter device, comprising:
receiving, with the filter, from a transmitting node on a data link, a bitstream comprising a string of packets formatted according to a data link protocol;
filtering, with the filter, the bitstream by identifying and omitting or deleting from the bitstream redundant packets used for maintenance of the data link; and
transmitting, with the filter, the filtered bitstream.

10. A method according to claim 9, further comprising receiving the transmitted filtered bitstream with a receiving node on the data link.

11. A method according to claim 10, wherein the receiving node is capable of receiving the unfiltered bitstream directly from the transmitting node over the data link, and is also capable of processing the unfiltered bitstream according to the data link protocol.

12. A method according to claim 9, wherein the transmitting node is a telephony signaling point, and wherein the data link protocol is part of a telephony signaling protocol.

13. A method according to claim 9, wherein indicia of the omitted or deleted packets is made available to a network device that receives the transmitted filtered bitstream.

14. A filter, comprising:
a receiver adapted to receive, from a transmitting node on a data link, a bitstream comprising a string of packets formatted according to a data link protocol;
filter logic coupled to the receiver and adapted to filter the bitstream by identifying and omitting or deleting from the bitstream redundant packets used for maintenance of the data link; and
a transmitter coupled to the filter and adapted to transmit the filtered bitstream.

15. A filter for filtering messages transmitted by a first signaling point and destined for a second signaling point, the filter comprising:
a receiver connected to the first signaling point by a first external communication channel and adapted to receive thereon the messages thereon;
processing logic, coupled within the filter to the receiver, adapted to receive the messages from the receiver, and adapted to filter the messages by deleting or ignoring redundant messages transmitted to fill-in or maintain a data link between the signaling points; and
a transmitter, coupled within the filter to the processing logic, adapted to receive the filtered messages and adapted to transmit them in a format capable of being processed by the second signaling point, whereby the second signaling point receives substantially fewer fill-in or maintenance messages.

16. An apparatus according to claim 15, further comprising a feedback mechanism adapted to make available to a receiver of the transmitted un-dropped packets indicia of the deleted or ignored redundant messages.

17. A filter according to claim 15, wherein the format transmitted by the transmitter is a format that the second signaling point would receive if the filter were not present or in use.

18. An apparatus for filtering data transmitted according to a telephony signaling protocol, the telephony signaling protocol comprising a physical layer protocol, a data link layer protocol, and a network layer protocol, the apparatus comprising:
a receiver capable of receiving frames sequenced and formatted according to the data link layer protocol, where the frames carry signaling units formatted according to the network layer protocol;
a processing circuit coupled to the receiver and capable of identifying frames in the bitstream that carry a network layer maintenance signaling unit that is duplicative of a maintenance signaling unit in a preceding frame; and
a transmitter coupled to the processing circuit and capable of transmitting the received frames less some or all of the identified frames.

19. An apparatus according to claim 18, further comprising a feedback mechanism adapted to make available to a receiver of the transmitted un-dropped packets indicia of the dropped packets.

20. An apparatus for use on a data link on which occasionally there is a repetitive packet pattern being transmitted to maintain the data link, the apparatus comprising:
an input module adapted to receive packets on the data link;
a pattern recognizer coupled to the input module and configured to drop packets by recognizing the repetitive pattern in the packets received by the input module and in response causing such recognized packets to be dropped from the data link, and passing packets not so recognized; and
an output module coupled to the input module and configured to prepare the un-dropped packets to be sent.

21. An apparatus according to claim 20, further comprising a feedback mechanism adapted to make available to a receiver of the un-dropped packets indicia of the dropped packets.

22. A transmission medium through which a signaling bitstream flows, the signaling bitstream comprising,
a stream of sequenced signal units formatted according to a network level signaling protocol and encapsulated in data link packets formatted according to a data link protocol, where for substantially all of the packets, no two sequential packets carry fill-in signal units that have identical forward and backward sequence numbers, and where the data link packets are unencapsulated.

23. A transmission medium according to claim 22, wherein the packets were originated on a data link by a signaling device during at least one idle period on the data link, and wherein at least two adjacent signal units are non-duplicate signal units that correspond to the idle period.

24. A computer-readable storage storing information enabling a computer to perform a process for filtering data link frames communicated over a data link between a data link transmitter and a data link receiver, where the frames are transmitted according to a data link protocol, the process comprising:
receiving the data link frames generated by the transmitter according to the data link protocol; and
based on the received data link frames, forwarding at least some of the received data link frames to the data link receiver while preventing the data link receiver from receiving at least some redundant frames that are for at least one of maintaining and continuously filling the data link.

25. An apparatus for use on a data link on which occasionally a repetitive packet pattern is transmitted to maintain the data link, the apparatus comprising:
receiving means for receiving packets on the data link;
processing means coupled to the receiving means for recognizing duplicate packets received by the input means and for causing such recognized duplicate packets to be dropped from the data link; and
output means coupled to the input module for outputting the packets not dropped by the processing means.
